(19) United States
(12) Patent Application Publication
(10) Pub. No.: US 2020/0006895 A1
(43) Pub. Date: Jan. 2, 2020

(54) Method and Device for Keeping Cables Joined

(71) Applicant: Gary A. Soutullo, Mobile, AL (US)

(72) Inventor: Gary A. Soutullo, Mobile, AL (US)

(21) Appl. No.: 16/443,465

(22) Filed: Jun. 17, 2019

Related U.S. Application Data
(60) Provisional application No. 62/691,173, filed on Jun. 28, 2018.

(51) Int. Cl. H01R 13/639

(52) U.S. Cl. CPC H01R 13/6392

(57) ABSTRACT

A device and method for keeping cables joined are provided in which a base (12) includes a plug opening (14) and at least two cable openings (16 and 18). Plugs (26 and 28) of cables (22 and 24) are passed through the plug opening (14) and join on one side of the base (12). Cables (22 and 24) pass though respective cable openings (16 and 18). Protrusions (20) may extend into the cable openings (16 and 18).

### CROSS-REFERENCE TO RELATED APPLICATION AND PRIORITY INFORMATION

This application claims the benefit of co-pending, prior filed U.S. provisional application no. 62/691,173 entitled “Method and Device for Keeping Cables Joined”, filed Jun. 28, 2018.

### TECHNICAL FIELD OF THE INVENTION

This invention relates generally to cables, and in particular to a method and device for keeping cables joined.

### BACKGROUND OF THE INVENTION

Frequently there is a need to join cables. For example (and without limitation), extension cords are often connected to power cords of electrically-powered devices. Problems and inconvenience arise when these cables come apart.

A need has arisen for and improved method and device for substantially preventing unwanted disconnection of cables.

### SUMMARY OF THE INVENTION

In accordance with the teachings of the present invention, a method and device keeping cables joined are provided which eliminate or substantially reduce the problems associated with prior art systems. In particular, a device for keeping cables joined is provided which includes a base with a plug opening, the plug opening being large enough for a cable plug to pass through the plug opening, and the base also includes at least two cable openings extending from the plug opening.

In a particular embodiment, at least one of the cable openings extends on a first side of the plug opening, and at least one of the other cable openings extends on a second side of the plug opening opposite the first side of the plug opening. Also, in any of the embodiments the base may be flexible.

In particular embodiments, the device includes at least one protrusion extending into each of the cable openings. The at least one protrusion may be any appropriate shape, including, without limitation, cross sectional shapes that are triangular, semicircular, or parabolic. The one or more protrusions may be integral with the base.

Also provided is a method of keeping cables joined, that includes passing a first plug of a first cable through a plug opening in a base, passing the first cable through a first cable opening having at least one protrusion, passing a second plug of a second cable through the plug opening, passing the second cable through a second cable opening having at least one protrusion, and connecting the first and second plugs.

Important technical advantages are provided by the present invention. In particular, an inexpensive, durable, and reliable cable-lock is provided by including cable openings in combination with a plug opening. Also, by using a flexible material for the device, cable separation stresses cause the device to lock tighter.

### BRIEF DESCRIPTION OF THE DRAWINGS

Reference is made in the description to the following briefly described drawings, which are not drawn to scale, and in which like reference numerals indicate like features:

FIG. 1 illustrates one embodiment of a device for keeping cables joined according to the teachings of the present invention; and

FIG. 2 illustrates the embodiment of FIG. 1 in use with cables.

### DETAILED DESCRIPTION OF THE INVENTION

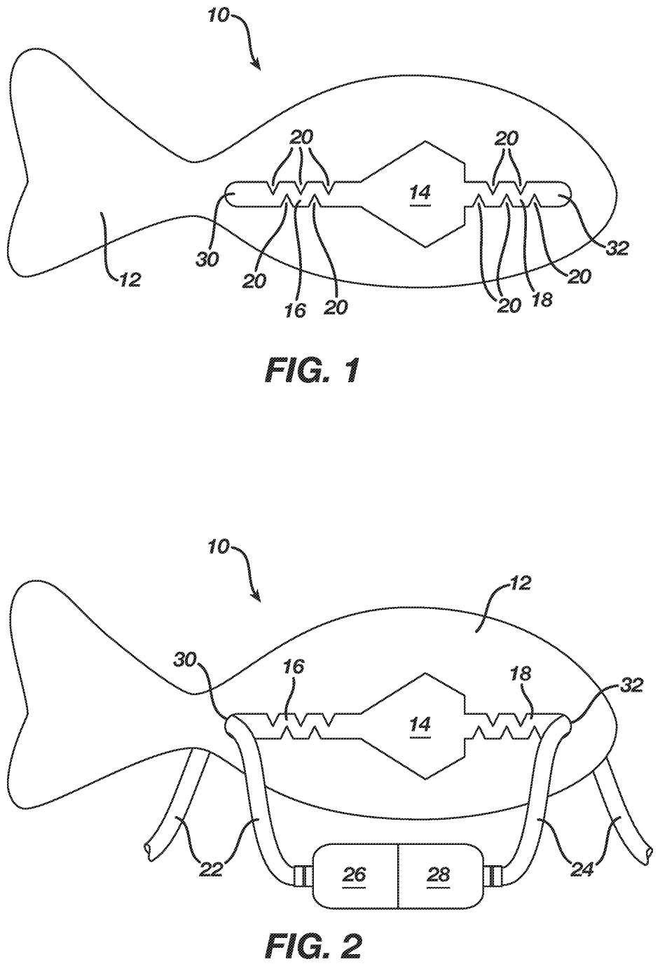

FIG. 1 illustrates one embodiment of a device 10 for keeping cables joined. As shown, device 10 includes a base 12. Base 12 includes plug opening 14 and at least two cable openings 16 and 18. These openings extend through the base 12. One or more protrusions 20 may extend from base 12 into cable openings 16 and 18. Although FIG. 1 shows device 10 is the shape of a fish, this fish-shape choice is ornamental, and any shape may be used.

An example of a use of the present invention is shown in FIG. 2. Cables 22 and 24 each include a respective plug 26 and 28. One such plug is male, and the other female. Plug 26 is passed through plug opening 14 to one side of the base 12, and cable 22 passes through cable opening 16. Plug 28 is passed through plug opening 14 to the same side of base 12 as plug 26, and cable 24 passes through cable opening 18. The cables 22 and 24 may pass though the respective cable openings 16 and 18 anywhere along the length of the cable openings 16 and 18. The cable openings 16 and 18 may be, although need not be, tapered, such that smaller cables pass through the cable openings 16 and 18 nearer the terminal ends 30 and 32, and larger cables closer to the plug opening 14 (e.g., the cable openings may be, although need not be, smaller at the terminal ends 30 and 32 than at their ends near the plug opening 14). The protrusions 20 help to hold cables anywhere along the length of the cable openings 16 and 18. The plugs 26 and 28 join on one side of the base 10. If desired, slack on cables 22 and 24 may be taken up to draw the plugs 26 and 28 closer to base 12.

In the presence of stresses on cables 22 and 24 that would tend to separate them, device 10 substantially prevents their unwanted disconnection. Because cable openings 16 and 18 are not large enough to allow plugs 26 and 28 to pass through them, they effectively lock plugs 26 and 28 in place by blocking movement of the plugs 26 and 28 away from each other. Furthermore, protrusions 20 assist in preventing cables and plugs on the plug side of base 12 from passing through the cable openings 16 and 18.

The base 12 is made of a flexible material, such as styrene-butadiene rubber. However, any suitable material may be used without departing from the intended scope of the present invention. The flexibility of base 12 augments the ability of device 10 to keep cables together, by allowing, among other things, the cable openings 16 and 18 (and protrusions 20) to tighten on the joined cables during times when stresses are present which would tend to pull the cables apart. Also, during such stresses, plug opening 14 tightens to effectively prevent the joined plugs from passing through the plug opening 14. Furthermore, the length of plug opening 14 is preferably less than the length of the joined plugs, to help prevent the plugs from passing through the plug opening 14 during times of separation stresses. A preferred durometer for base 10 is in the range of 70 to 90, although any suitable durometer material may be used. Also, although styrene-butadiene rubber is preferred, it should be understood that base 10 may be made of any suitable material, and need not be rubber or flexible.

The one or more protrusions 20 may be any appropriate shape, including, without limitation, cross-sectional shapes that are triangular, semicircular, or parabolic. The protrusions 20 may be integral with the base 12.

Although one plug opening 14 and two cable openings 16 and 18 are shown, more such openings may be included with departing from the intended scope of the present invention. Also, although five protrusions 20 are shown extending into each cable opening, more or fewer may be used without departing from the intended scope of the present invention.

The present invention also encompasses systems that employ the device 10 along with two or more cables to be joined.

Although the present invention has been described in detail, it should be understood that various changes, alterations, substitutions, additions, and modifications could be made without departing from the intended scope of the invention, as defined in the following claims.

What is claimed is:

1. A device for keeping cables joined, comprising:
a base comprising a plug opening, the plug opening being large enough for a cable plug to pass through the plug opening; and
the base further comprising at least two cable openings extending from the plug opening.

2. The device of claim 1, wherein at least one of the cable openings extends on a first side of the plug opening, and at least one of the other cable openings extends on a second side of the plug opening opposite the first side of the plug opening.

3. The device of claim 1, wherein the base is flexible.

4. The device of claim 1, and further comprising at least one protrusion extending into each of the cable openings.

5. The device of claim 4, wherein the at least one protrusion is approximately triangular in cross section.

6. The device of claim 4, wherein the at least one protrusion is approximately semicircular in cross section.

7. The device of claim 4, wherein the at least one protrusion is approximately parabolic in cross section.

8. The device of claim 4, wherein the at least one protrusion is integral with the base.

9. The device of claim 8, wherein the base is flexible.

10. The device of claim 1, comprising five protrusions extending into each cable opening, and wherein each protrusion is integral with the base.

11. The device of claim 10, wherein the base is flexible.

12. A method of keeping cables joined, comprising:
passing a first plug of a first cable through a plug opening in a base;
passing the first cable through a first cable opening having at least one protrusion;
passing a second plug of a second cable through the plug opening;
passing the second cable through a second cable opening having at least one protrusion; and
connecting the first and second plugs.

13. A device for keeping cables joined, comprising:
a base comprising a plug opening, the plug opening being large enough for a cable plug to pass through the plug opening;
the base further comprising at least two cable openings extending from the plug opening; and
at least one protrusion extending into each of the cable openings.

14. The device of claim 13, wherein at least one of the cable openings extends on a first side of the plug opening, and at least one of the other cable openings extends on a second side of the plug opening opposite the first side of the plug opening.

15. The device of claim 13, wherein the base is flexible.

16. The device of claim 13, wherein the at least one protrusion is approximately triangular in cross section.

17. The device of claim 13, wherein the at least one protrusion is approximately semicircular in cross section.

18. The device of claim 13, wherein the at least one protrusion is integral with the base.

19. The device of claim 13, comprising five protrusions extending into each cable opening, and wherein each protrusion is integral with the base.

20. The device of claim 19, wherein the base is flexible.
